(19) United States
(12) Patent Application Publication
(10) Pub. No.: US 2012/0136854 A1
(43) Pub. Date: May 31, 2012

(54) METHOD OF OBTAINING A CORRESPONDENCE BETWEEN A PROTEIN AND A SET OF INSTANCES OF MUTATIONS OF THE PROTEIN

(76) Inventors: Rajaraman Kanagasabai, Singapore (SG); Christopher James Oliver Baker, Grand Bay-Westfield (CA)

(21) Appl. No.: 13/260,722

(22) PCT Filed: Mar. 26, 2010
(86) PCT No.: PCT/SG2010/000118

§ 371 Date: Jan. 24, 2012

(30) Foreign Application Priority Data
Mar. 27, 2009 (SG) 200902159-3

(51) Int. Cl. G06F 17/30

(52) U.S. Cl. 707/723; 707/E17.084

(57) ABSTRACT

A method of obtaining a correspondence between a protein and a set of instances i=1 . . . , k of mutations of the protein is disclosed. The method includes: a) matching a plurality of protein sequences in a sequence bank to at least one expression formed using the set of instances of mutations wherein each protein sequence comprises a plurality of amino acid residues of the protein's constituent peptides and wherein the at least one expression includes wild type residues of a subset of the instances of mutations in the order of their positions within the protein, and differences in said positions of the successive wild type residues in the expression; b) ranking the protein sequences according to the similarity of the protein sequences to the set of instances of mutations, the similarity of the protein sequences to the set of instances of mutations being determined by the matching in step (a); and c) retaining the protein sequence with the highest similarity ranking, said correspondence being a relationship between the retained protein sequence and a subset of the instances of mutations corresponding to the retained protein sequence.

### FIELD OF THE INVENTION

The present invention relates to a method of obtaining a correspondence between a protein and a set of instances of mutations of the protein. The present invention further relates to a method of building a knowledge base comprising the correspondences between a plurality of proteins and instances of mutations of the plurality of proteins.

### BACKGROUND OF THE INVENTION

Mutations can be caused by transcription errors in the genetic material, deliberate cellular control, damage due to radiation or chemical mutagens, or retroviral infection. Mutations may also be introduced deliberately through rational design and directed evolution. Although a small percentage of mutations confer advantages, the majority of mutations tend to have neutral or deleterious impacts leading, in some cases, to the disruption of molecular functions or biological processes and possibly, diseases in higher organisms.

Numerous studies have been conducted on mutations over the years, hence generating rich and abundant sources of information¹⁻⁸. Unfortunately, the information is scattered in a variety of resources, including public and private biomedical literature databases. To access this information, a researcher must scour the disparate resources for relevant citations. Furthermore, in order to convert the information into actionable knowledge, the researcher has to map a mutation to its associated protein. This often requires specific expertise or domain knowledge. The task is further complicated by the heterogeneous document formats, languages style and the slow adoption of common and standardized vocabulary to describe the mutations. As a result, integrating this information is time-consuming and susceptible to errors.

An example scenario is illustrated as follows. When scanning PubMed¹⁵ literature for information on a particular protein (or protein family), a user, such as a protein engineer or a structural biologist, typically has a specific research question in mind. Of critical importance is the interpretation of new insights from experimentally introduced perturbations, such as point mutations, in the context of the researcher's current understanding of a protein, its properties and its structure. How does the newly reported mutation directly or indirectly affect the kinetics of protein-ligand binding or the conformation of an interaction interface? To embark on such an investigation, the user may, for example, record the mutation annotations in a paper and retrieve sequence information from sequence databases such as GenBank¹⁶ or Swiss-Prot/UniProt¹⁷, and where available, structure information from the Protein Data Bank (PDB)¹⁸. The user then identifies the positions that the mutant residues occupy on the structure by inspecting the structure file. Before proceeding with modelling the 3D structure of the mutated protein, the user may also need to address issues such as the need to remap coordinates of the residues to accommodate targeting signals found in the sequence or inconsistent sequence-structure information which may occur in the PDB file²¹. From this simplified example scenario, the following observations can be made: (a) multiple steps need to be carried out, (b) integration of data from various sources are required, (c) thorough checks are required to avoid propagating errors to the subsequent steps rendering the results unusable, (d) many components in the process readily lend themselves to automation.

The key, challenge is thus how to, with minimal intervention from the user, extract information from disparate raw-text literature and existing structured sources such as mutation databases, and present this information as an organized and integrated view. Up until recently this has been the mandate of manual curation projects^{8, 9} which have resulted in the creation of domain specific mutation databases which now exist in their hundreds, despite their eventual obsolescence when funding for curation is not renewed. In such cases, these repositories of legacy data are only updated by enthusiastic end users. Running in parallel with this trend, a series of independent initiatives, which focus on developing automated techniques to facilitate the extraction of mutation specific annotations from texts for subsequent reuse in bioinformatics analyses, has emerged. Through experimentation with machine learning, natural language processing, ontologies and other Artificial Intelligence technologies, automated mutation extraction is becoming a more mature and realizable goal.

Furthermore, mutation analysis requires the validation of the detected and normalized mutation entity on its corresponding protein sequence which may be obtained from web databases such as UniProtKB/GenBank based on the corresponding identified protein entity. This may require the correct identification of the difference between the numbering used by the authors reporting the mutation and the sequence as obtained from UniProtKB/GenBank. For multiple mutations on a single protein or a series of mutations, the legitimacy can be easily verified using the offsets between the mutations³⁶. On the other hand, this is more difficult for a single mutation as a match of the amino acid of the mutation on the sequence might be purely coincidental. Given a protein-mutation tuple, mutation grounding is the identification of the positionally correct location of a mutation to match its corresponding protein sequence retrieved from the web databases and is an important step in achieving automated mutation extraction.

The following initiatives have pioneered the use of text mining techniques to recognize, extract and ground mutation entities for automated mutation extraction. An early work MuteXt¹⁰ focused on the mutation extraction performance for single-point mutations of G protein-coupled receptors and nuclear hormone receptors and is an example of a system that attempts to perform mutation grounding. Rebholz-Schuhmann et al.¹¹ focused primarily on the extraction of disease related mutation-gene pairs whereas MutationFinder¹² reported a rule-based system for finding point mutation mentions from abstracts. Baker and Witte¹³ discussed the Mutation Miner system and a mutation extraction-dependent task, namely the mutated-protein structure annotation. Mutation Miner is also a system that attempts to perform mutation grounding. Further to this, Gabdoulline et al. reported the customization of the ProSAT structure annotation tool¹⁴ to support the upload of mutation annotations from selected fields in the BRENDA database or from a custom designed XML format. In addition, Kanagasabai et. al³⁶ proposed a multi-tier system to automate the workflow required to support a defined scenario, whereby the system is capable of fetching documents from PubMed on the basis of specific keywords and processing the fetched documents or documents input directly by the user. The documents are parsed to extract the relevant annotations and mutation information. In Kanagasabai et. al, information, such as sequence and similarity search results, are generated by third party tools and stored as instances of an OWL-DL ontology¹⁹. The ontology is later queried and the information undergoes application-specific data processing where the mutated residues are mapped to the structure before being displayed in a 3D visualization.

In summary, existing approaches to mutation extraction are predominantly based on search using regular expressions and rule sets, sometimes in conjunction with protein, gene, or organism named entity recognition. Gold standard corpora³² are being created, and promising evaluations of the performance and accuracy of mutation extraction techniques are emerging. Disambiguation of DNA vs. protein mutations is also shown to be possible³³. In parallel, there is also an ongoing discussion on the appropriate metrics and evaluation strategies³⁴ and the need for a benchmark by which to systematically compare existing and future mutation extraction applications. Despite the numerous reports on mutation extraction techniques, there are few studies on the grounding of normalized mutations to real-world entities, such as grounding of allelic variations to dbSNP entries¹¹ and the grounding of point mutations to protein sequences. However, this is an important step to allow the extracted mutations and annotation sentences to be reused for machine learning or structure annotation.

### SUMMARY OF THE INVENTION

The present invention aims to provide a method for obtaining a correspondence between a protein and instances of mutations of the protein and for building a knowledge base with the correspondences obtained. Note that the term “knowledge base” is used in this document to mean a database with semantic storage.

In general, the invention proposes retrieving a plurality of protein sequences from sequence banks, for example GenBank, using the name of the protein and retaining only the protein sequence with the best match to the instances of mutations. This is performed by forming at least one expression that includes firstly, wild type residues of the mutations with the residues arranged according to the order of their positions in the protein, and secondly, the differences in said positions of the wild type residues in the expression (in other words, the offsets between the wild type residues), and then matching the at least one expression to the retrieved protein sequences. Based on this matching, the protein sequence with the best match is found and is retained.

Specifically, a first aspect of the invention is a method of obtaining a correspondence between a protein and a set of instances i=1 . . . , k of mutations of the protein, the method including: a) matching a plurality of protein sequences in a sequence bank to at least one expression formed using the set of instances of mutations wherein each protein sequence comprises a plurality of amino acid residues of the protein's constituent peptides and wherein the at least one expression includes wild type residues of a subset of the instances of mutations in the order of their positions within the protein, and differences in said positions of the successive wild type residues in the expression; b) ranking the protein sequences according to the similarity of the protein sequences to the set of instances of mutations, the similarity of the protein sequences to the set of instances of mutations being determined by the matching in step (a); and c) retaining the protein sequence with the highest similarity ranking, said correspondence being a relationship between the retained protein sequence and a subset of the instances of mutations corresponding to the retained protein sequence. Note that the term “subset” is used in this document to include also the set of all of the instances of the mutations.

Since the instances of mutations may, for example, be extracted through text mining, they may include false positives. Similarly, since the protein sequences may, for example, be obtained from GenBank, they may contain many sequences of the same protein obtained via different sequencing methods and hence may include errors. The first aspect of the invention is advantageous as it provides a robust method of grounding the mutations (which may contain false positives) to the protein sequences (which may contain errors). Furthermore, the first aspect of the invention is advantageous as it does not merely retain the first protein sequence in the list of protein sequences that matches the at least one expression. Rather, the first aspect of the invention attempts to match every protein sequence retrieved from the sequence banks and retains only the protein sequence with the best match. Hence, it is more accurate.

The step (a) may be performed by repeatedly performing the following sub-steps: (i) forming a subset of the instances of mutations, the subset including a plurality of the instances of mutations; (ii) forming a corresponding expression for the subset, wherein the corresponding expression includes the wild type residues of the subset of mutations in the order of their positions within the protein, and the differences in said positions of the successive wild type residues of the subset of mutations; and (iii) matching the protein sequence to the corresponding expression; and extracting the longest corresponding expression that matches the protein sequence.

The invention further proposes building a knowledge base comprising correspondences between a plurality of proteins and instances of mutations of the plurality of proteins whereby the correspondences are obtained using the first aspect of the present invention.

The invention may alternatively be expressed as a computer system for performing such a method. This computer system may be integrated with a device for collating and processing text documents. The invention may also be expressed as a computer program product, such as one recorded on a tangible computer medium, containing program instructions operable by a computer system to perform the steps of the method.

### BRIEF DESCRIPTION OF THE FIGURES

An embodiment of the invention will now be illustrated for the sake of example only with reference to the following drawings, in which:

FIG. 1 illustrates an example mSTRAP system architecture which is an embodiment of the invention;

FIG. 2 illustrates an example OWL-DL mutation ontology employed in the system of FIG. 1;

FIG. 3 illustrates a flow diagram of a method of building a knowledge base in the form of an ontology comprising correspondences between a plurality of proteins and instances of mutations of the plurality of proteins according to an embodiment of the present invention; and

FIG. 4 illustrates a portion of an example output obtained using method 300.

### DETAILED DESCRIPTION OF THE EMBODIMENTS

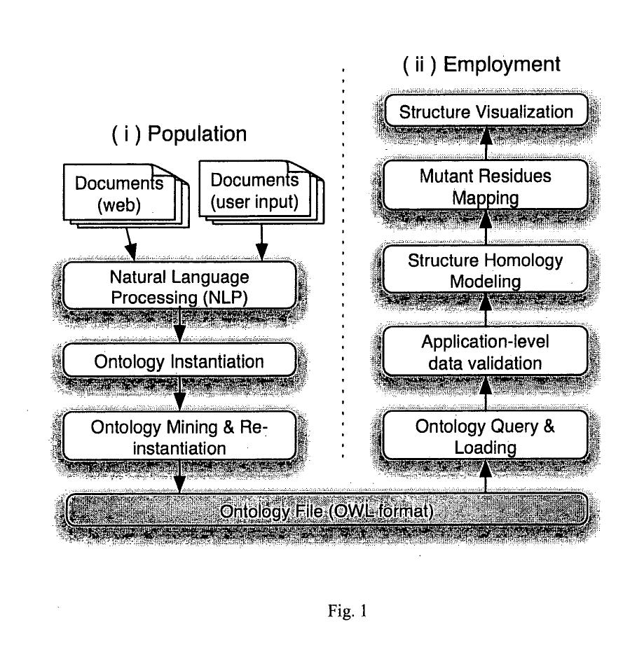

Referring to FIG. 1, a schematic illustration of an example mSTRAP system architecture is shown. mSTRAP is a multi-tier system that can be used to automate the workflow required to support mutation studies. This system is capable of fetching documents from web databases for example, PubMed on the basis of specific keywords and is also capable of processing the fetched documents or documents input directly by the user. The documents are parsed to extract the relevant annotations and mutation information.

As shown in FIG. 1, in general, the mSTRAP system coordinates two main pipelines: (i) the ontology population workflow (shown as (i) Population) comprising document retrieval, information extraction, data integration, and ontology instantiation and (ii) the ontology employment workflow (shown as (ii) Employment) comprising query of the populated ontology, protein structure coordinate retrieval, homology modelling if the structure is unavailable, mutant residue mapping and protein structure visualization. A key subsystem in the ontology population workflow of FIG. 1 instantiates the ontology with protein names and mutations for example, point mutations, extracted through text mining from the input documents and then grounds the text-derived mutations onto their corresponding protein sequences. The ontology is later queried in the ontology employment workflow and the information undergoes application-specific data processing where the mutated residues are mapped to the structure before being displayed in a 3D visualization.

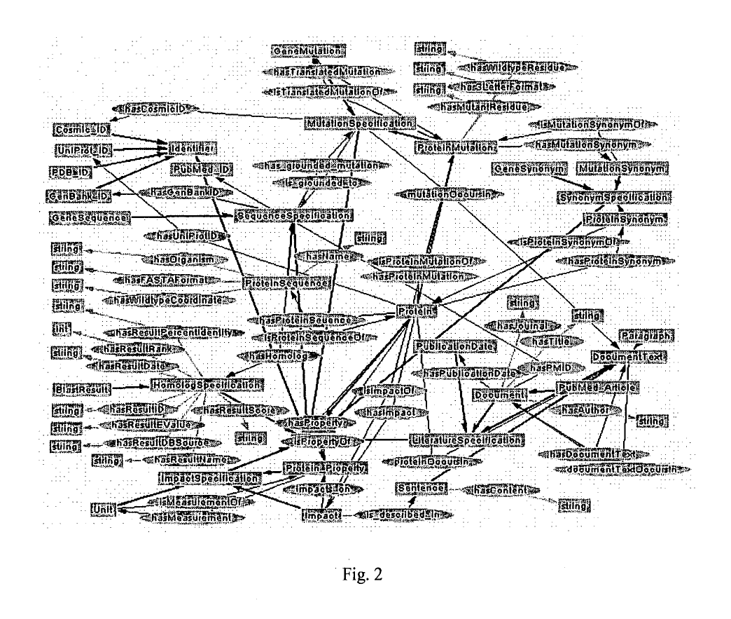

In one example, the ontology is designed to facilitate data integration in a focused application domain and is scripted in the W3C-endorsed standard, (the Web Ontology Language (OWL)) using the TopBraid Composer (http://www.topbraid composer.com/). FIG. 2 illustrates such an example ontology employed in the system of FIG. 1 whereby the ontology shows the full conceptualization distinguishing object and data type properties. The conceptualization captures core concepts and relations (as object properties) relevant to mutation extraction from the literature and corresponding protein sequence retrieval. Although the above are sufficient to facilitate integration requirements, more extensive information about the data aggregated by the workflow can also be captured in the data type properties. As shown in FIG. 2, information, such as sequence and similarity search results generated by third party tools are also stored as instances of the OWL-DL ontology¹⁹.

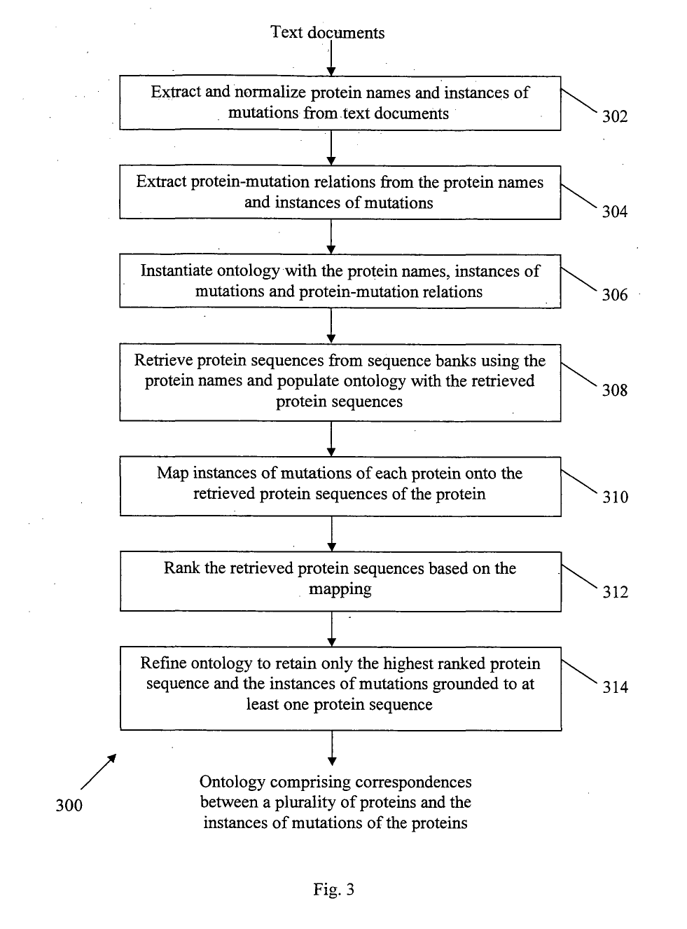

Referring to FIG. 3, the steps are illustrated of a method 300 which is an embodiment of the present invention, and which builds a knowledge base in the form of an ontology comprising correspondences between a plurality of proteins and instances of mutations of the plurality of proteins. Each of these correspondences is obtained via mutation extraction and grounding. Method 300 is a more detailed explanation of a portion of the ontology population workflow in FIG. 1.

The inputs to method 300 are text documents which may be text content downloaded through a PubMed search, USPTO search, Google search and/or obtained by parsing a researcher's personal documents. The text of these text documents are processed by converting them from their original formats (for example, pdf) to ascii text. After this processing, the text documents are then passed as input to method 300.

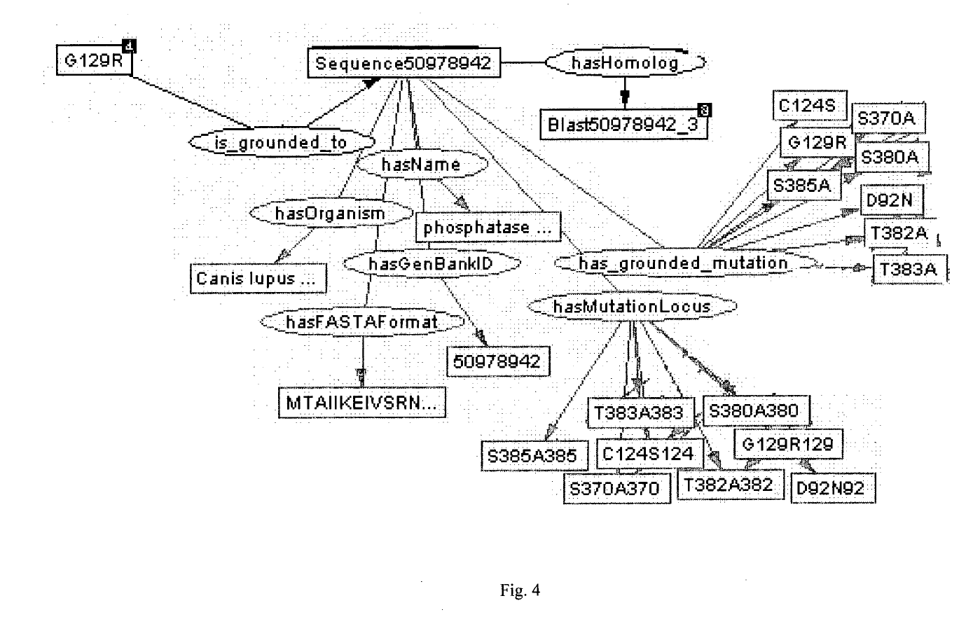

In method 300, protein names and instances of mutations in the input text documents are first extracted and normalized in step 302. Using these extracted and normalized protein names and instances of mutations, protein-mutation relations are extracted in step 304. Protein-mutation relations are the relations connecting the normalized protein names and the instances of mutations, in particular, a protein-mutation relation describes the protein that is mutated by the instance of mutation. In step 306, the ontology is instantiated with the protein names, instances of mutations and protein-mutation relations. In step 308, protein sequences are retrieved from sequence banks using the protein names and the ontology is populated with the retrieved protein sequences. Each retrieved protein sequence comprises a plurality of amino acid residues of the protein's constituent peptides. In step 310, maximal mapping of the instances of mutations onto the retrieved protein sequences for each protein is performed. This is followed by the ranking of the retrieved protein sequences of the protein based on the mapping in step 312. The ontology is then refined in step 314 to retain only the highest ranked protein sequence and the plurality of instances of mutations grounded to it. The output of method 300 is thus an ontology comprising correspondences between a plurality of proteins and instances of mutations of the plurality of proteins. FIG. 4 illustrates a portion of an example output obtained using method 300.

The above steps of method 300 will now be described in more detail.

Step 302: Extract and Normalize Protein Names and Instances of Mutations from Text Documents

In step 302, instances of mutations are extracted from the input text documents by for example, using regular expressions and/or with rule sets whereas protein names are extracted from the input text documents by for example, using curated protein name gazetteer lists. These extracted entities are then normalized. Prior to the normalization of these extracted entities, the co-references of the extracted protein names may be recognized using anaphora resolution.

In one example, step 302 is performed according to the following steps.

A text-mining toolkit BioText which uses a gazetteer component is first employed to process the text documents and extract the protein names and instances of mutations from the text documents. The gazetteer component in BioText uses term lists and regular patterns to match against the token of a processed text and then tags the terms found.

For example, the manually curated protein name list from Swiss-Prot may be used for extracting the protein names from the text documents by matching the processed text of the text documents against the protein name list. This protein name list from Swiss-Prot may be further enhanced by incorporating all canonical names and synonyms before being used to perform the extraction. Furthermore, instances of mutations in the form of point mutations may be extracted by matching the processed text of the input text documents against a regular expression of the form as shown in Equation (1).

[A-Z]([a-z][a-z])?\-?\d+[A-Z]([a-z][a-z])? (1)

The following rules must be satisfied before an extracted instance of mutation is classified as a true positive: (i) both the wild type and mutant residues of the extracted instance of mutation must match valid names or letters and (ii) the wild type and mutant residues of the extracted instance of mutation must be different. If either of these rules is not satisfied, the extracted instance of mutation is classified as a false positive and is deleted. For example, O9X will be identified as a false positive and will be deleted since it does not satisfy rule (i).

Subsequently, the extracted protein names and instances of mutations are normalized. Protein names are normalized to the canonical names in the protein name list used for extracting the protein names from the text documents, for example, the protein name list from Swiss-Prot. After the normalization, the protein names are then grounded to the identifiers in the protein name list, for example the Swiss-Prot Identifiers in the protein name list from Swiss-Prot. Instances of mutations are normalized to a wNm format. For mutations containing three letter codes, this is performed by a mapping of the three-letter to one-letter amino acid coding. In the wNm format, w and m are one-letter amino-acid codes whereby w represents the wild type residue of the extracted instance of mutation, m represents the mutant residue of the extracted instance of mutation and N is a number indicative of the position of the wild type residue w within the protein.

Step 304: Extract Protein-Mutation Relations from the Protein Names and Instances of Mutations

In step 304, protein-mutation relations are extracted from the protein names and instances of mutations obtained from step 302. Protein-mutation relation extraction is the task of detecting a mutational change described in a document and identifying the protein it is modifying. This may be performed by, for example, using sentence level co-occurrences.

In one example, every input text document is first parsed to extract the sentences in which the protein names and instances of mutations extracted in step 302 occur. Then, a relation mining approach is adopted on these extracted sentences. In the relation mining approach, two entities are said to be related if they co-occur in a sentence. In other words, an instance of mutation is determined to be the instance of mutation of a protein if the instance of mutation and the name of the protein appear in a same sentence. For example, using the relation mining approach, it can be inferred from the sentence “Compared with the wild type form of xylanase II, E210D had >100-fold and E210S 1,000-fold lower enzymatic activity” that xylanase II is related to E210D and E210S. Using this approach, protein-mutation tuples are extracted in step 304 along with the respective sentences in which they co-occur.

Step 306: Instantiate the Ontology with the Protein Names, Instances of Mutations and Protein-Mutation Relations

In step 306, the ontology is instantiated with the protein names, instances of mutations and protein-mutation relations using for example, the Jena API (http://jena.sourceforge.net/).

In one example, the protein names and instances of mutations are instantiated as class instances into the respective ontology classes (as tagged by the gazetteer) and the protein-mutation relations are instantiated as Object Property instances. For example, the protein names and instances of mutations may be instantiated as class instances, ‘Protein’ and ‘ProteinMutation’, respectively whereas for every protein-mutation relation extracted in step 304, an instance of the object property ‘hasProteinMutation’ may be created. Object property instances for the synonyms (if available) of the extracted protein names and external database identifiers of the proteins may also be added. Instances for the corresponding reverse properties, for example ‘isProteinMutationOf’, may also be created.

Step 308: Retrieve Protein Sequences from Sequence Banks Using the Protein Names and Populate the Ontology with the Retrieved Protein Sequences

In step 308, protein sequences are retrieved from sequence banks (or in other words, web databases) such as the GenBank protein sequence database using the extracted protein names and the ontology is then populated with these protein sequences.

In one example, for every protein in the instantiated ontology, a query is first performed on the GenBank protein sequence database using its protein name. FASTA formatted sequences are then retrieved using the Entréz Programming Utilities: EUtils (http://www.ncbi.nlm.nih.gov/entrez/query/static/eutils_help.html) provided by NCBI. Next, the FASTA sequences are populated under the ‘ProteinSequence’ class in the ontology and object property instances of ‘hasProteinSequence’ are created for the proteins. The object property instances relate the proteins to the retrieved FASTA sequences. Information about each protein sequence such as the raw FASTA sequence, rank, date, etc. are instantiated as data type properties. Instantiating the ontology with all the retrieved protein sequences and the extracted mutations before proceeding to the mapping in step 310 is advantageous as the ontology helps to add semantics to the retrieved protein sequences for example, by organizing the sequences based on a protein classification.

Step 310: Map the Instances of Mutations of Each Protein onto the Retrieved Protein Sequences of the Protein

In step 310, instances of mutations of each protein are mapped onto the retrieved protein sequences of the protein using an offset analysis. This is done using the expression of the form as shown in Equation (2) whereby w₁N₁m₁, w₂N₂m₂, . . . , wₖNₖmₖ are instances of the k mutations to be mapped. Each instance i=1, . . . k specifies a corresponding wild type residue wᵢ, a corresponding number Nᵢ indicative of the position of the wild type residue wᵢ within the protein, and a corresponding mutant residue mᵢ which is made to the corresponding residue wᵢ. To form the expression in Equation (2), the instances of the mutations to be mapped are sorted in an ascending order of Nᵢ and fᵢ=Nᵢ₊₁−Nᵢ are the offsets between adjacent mutations i.e. the distances between the wild type residues wᵢ and wᵢ₊₁.

w₁·{f₁}w₂·{f₂} . . . {fₖ₋₁}wₖ (2)

If all the mutations are true positives, then this regular expression as shown in Equation (2) can be applied to the retrieved FASTA formatted protein sequences to return candidate sequences. However, even a single false positive can break this process often resulting in no matches. Thus, in step 310, a maximal mutation mapping technique is used. The maximal mutation mapping technique is described as follows.

For every protein, instances of the mutations from each free-text document are processed separately. Firstly, instances of the mutations of a protein are ordered in an ascending order based on their positions Nᵢ within the protein. A greedy algorithm is then used to map as many instances of mutations as possible to each retrieved protein sequence of the protein until the regular expression shown in Equation (2) fails to return any match. In other words, the greedy algorithm is matching the retrieved protein sequences to the regular expression shown in Equation (2). The more similar the protein sequence is to the expression, the more the number of instances of the mutations mapped.

The steps of an example greedy algorithm are described as follows. This example greedy algorithm potentially returns successful grounding of sizes greater than or equal to 2.

```
1.  Let P be a protein and M₁, M₂, . . ., Mₖ, where Mᵢ = wᵢNᵢmᵢ ,
k ≧ 2, be the k associated mutations of the protein P, wherein the
mutations M₁, M₂, . . ., Mₖ are sorted in the ascending order of Nᵢ.
      Let S be the list of protein sequences retrieved by querying
sequence banks using the name of the protein P.
2.  Let Ω ← Φ , where Φ is the null set;
3.  For x = 1, 2, ... k−1
4.  Let G ← { Mₓ}
5.  For y = x+1, ... k
6.  G ← G U{ M_{y}}
7.  Using the mutations in G, construct a regular expression
              w₁.{f₁}w₂.{f₂}. . .{f_{|G|-1}}w_{|G|} as in Equation (2),
              and match it against S. Let N_{SM} be the number of
              successful matches.
8.  If N_{SM} = 0 , then
9.  G ← G − { M_{y}}
10.  Remove all members of Ω that are subsets of G.
11.  Add G to Ω if |G| > 1, and no member of Ω is a
                  superset of G.
12.  EndIf
13.  EndFor
14.  If N_{SM} ≧ 1, Then
15.  Remove all members of Ω that are subsets of G.
16.  Add G to Ω if |G| > 1, and no member of Ω is a
              superset of G.
17.  EndIf
18.  EndFor
19.  Return Ω as the set of groundings.
```

The following examples illustrate how the example greedy algorithm as described above works:

### Example 1

### Consider {M₁, M₂, M₃, M₄} where Only M₃ is a False Positive

Both loops (steps 3 & 5) will run till x=1 and y=3. At this stage, the “If condition” in step 8 will be satisfied and {M₁, M₂} will be added as a successful grounding. Then the inner loop (step 5) continues till the end (y=4) and exits to the outer loop in step 14. The “If condition” will be true when y=4, and {M₁, M₂, M₄} will be added as a successful grounding whereas {M₁, M₂} is removed as it is a subset of G={M₁, M₂, M₄}. The outer loop continues but no new grounding is added in step 16, since {M₂, M₄} is covered by an already-existing grounding.

### Example 2

### Consider {M₁, M₂, . . . , M₅} where all M₁, M₂, . . . , M₅ are all True Positives

With x=1 in the outer loop, the inner loop will run through all y=2, . . . , 5 and will end with N_{SM}=1. This will be detected in step 14, and {M₁, M₂, . . . , M₅} will be added as a successful grounding to Ω. The outer loop will continue from x=2 and so on but no new grounding will be added because all further groundings will be detected as subsets of Ω in Step 16.

### Example 3

### Consider {M₁, M₂, . . . , M₅} where all M₁, M₂, . . . , M₅ are False Positives (or Just 1 of them is a True Positive)

The “If condition” in step 8 will always be satisfied, but no grounding will be added to Ω since G will always be a singleton set i.e. |G|>1 will always be true. Thus, a null set will be output in Step 19.

For each protein extracted from the text documents, the above example greedy algorithm is repeatedly performed on the protein sequences retrieved from the database for the protein.

The above example greedy algorithm repeatedly performs the following steps of: firstly, forming a subset of the instances of mutations, the subset including a plurality of the instances of mutations; secondly, forming a corresponding expression for the subset whereby the corresponding expression includes the wild type residues of the subset of mutations in the order of their positions within the protein, and the differences in said positions of the successive wild type residues of the subset of mutations; and thirdly, matching the protein sequence to the corresponding expression. The greedy algorithm then extracts the longest corresponding expression that matches the protein sequence.

As shown above, the greedy algorithm involves an inner loop and an outer loop, such that a generation of subsets is formed by every complete cycle of the inner loop. The subsets of the instances of mutations comprise at least one generation of subsets which share a first instance of mutation, each generation of subsets formed by: generating a first subset of the generation consisting of said first instance of mutation and successively generating further subsets by: firstly, adding to the most recently generated subset of the generation an instance of mutation at a subsequent position within the protein, to form a new subset of the generation; secondly, generating a corresponding said expression for the new subset; and thirdly, determining whether the corresponding expression for the new subset of the generation matches the protein sequence, and if the protein sequence does not match the corresponding expression formed for the new subset of the generation, the instance of mutation at said subsequent position is removed. Each generation of subsets ceases after an instance of mutation at the furthest position, k, within the protein is included.

After the completion of every cycle of the inner loop, a new cycle of the inner loop begins to form a new generation of subsets. The subsets in each generation begin with an instance of mutation at a position subsequent to the position of the instance of mutation the subsets in a previous generation begin with. Furthermore, the subsets in the final generation comprise two elements.

The above example greedy algorithm is advantageous as, the algorithm is not halted once it encounters a single false positive since the single false positive is merely skipped over. Also, by having an inner loop and an outer loop, different generations of subsets beginning with different instances of mutations can be evaluated. Thus, longer hits can be achieved by the above greedy algorithm, in other words, the groundings achieved by this greedy algorithm comprise more instances of mutations.

### Step 312: Rank the Retrieved Protein Sequences Based on the Mapping

In step 312, the retrieved protein sequences for each protein are ranked according to how similar they are to the regular expression (in Equation (2)) formed by the instances of mutations of the protein. In one example, this is performed by using a scoring function that computes the number of mutations mapped onto each protein sequence. A protein sequence with a greater number of mutations mapped onto it is given a higher similarity ranking. In another example, if the example greedy algorithm as described above is used, the ranking of the protein sequences is such that a protein sequence is given the highest similarity ranking if its corresponding longest matching expression returned by the greedy algorithm is the longest among all the protein sequences.

In the event that there is more than one protein sequence having the highest similarity ranking, these protein sequences are ranked again by computing a sequence offset distance. A protein sequence is given a higher rank if its sequence offset distance is smaller. The sequence offset distance depends on the distances between the instances of mutations mapped to the protein sequence. In one example, it is the average distance between these instances of mutations. If the greedy algorithm as described above is used, the sequence offset distance of a protein sequence depends on the distance(s) between the instances of mutations in the subset of instances of mutations corresponding to the longest matching expression obtained for the protein sequence. In one example, it is the average distance between the instances of mutations in this subset.

### Step 316: Refine the Ontology to Retain Only the Highest Ranked Protein Sequence and the Instances of Mutations Grounded to at Least One Protein Sequence

In step 316, the ontology is refined by retaining only the highest ranked protein sequence and the instances of mutations grounded to at least one protein sequence.

In one example, the top hit sequence, in other words, the protein sequence with the highest similarity ranking is selected and retained whereas all the other protein sequences and their properties are un-instantiated. Instances of mutations that are not grounded to any protein sequence are recognized as false positives and are uninstantiated. Furthermore, instances of mutations not grounded to the top hit sequence are also uninstantiated unless they are grounded to other sequence(s). On the other hand, positions of the instances of mutations successfully grounded to the top hit sequence are stored as data type properties of the ProteinSequence class instance. A class instance of the correspondence of the retained protein sequence is also created in the ontology. The correspondence of the retained protein sequence is defined as the relationship between the retained protein sequence and the subset of the instances of mutations corresponding to the retained protein sequence (or, if the above example greedy algorithm is used, the subset of mutation instances used to form the longest matching expression corresponding to the retained protein sequence).

### Performance Evaluation

To evaluate method 300, a gold standard corpus using the COSMIC database (http://www.sanger.ac.uk/genetics/CGP/cosmic/) is built. Using three target protein families: PIK3CA (42 full-text papers), FGFR3 (37 full-text papers) and MEN1 (19 full-text papers), the performance of the protein-mutation tuple extraction task (i.e. steps 302-304) and the mutation grounding task (i.e. steps 310-314) of method 300 were evaluated.

For this performance evaluation, two measures, namely (i) precision and (ii) recall are measured. For the protein-mutation tuple extraction task, precision is defined as the fraction of the correctly extracted protein-mutation tuples over all the extracted protein-mutation tuples, whereas recall is defined as the fraction of the correctly extracted protein-mutation tuples over all the protein-mutation tuples which should have been extracted. For the mutation grounding task, precision is defined as the fraction of the correctly grounded sequences over all the grounded sequences, whereas recall is defined as the fraction of the correctly grounded sequences over all the sequences that should have been grounded. In the mutation grounding task, sequences retrieved from the databases were checked using pair wise sequence alignment to ensure more than 99% homology with gold standard protein sequences.

Table 1 shows the results obtained using method 300. As shown in Table 1, high precision and recall are achieved in method 300 for both the protein-mutation tuple extraction task and the mutation grounding task. In contrast, the precision and recall achieved by existing systems (such as the MutationMiner or the MugeX) in the protein-mutation tuple extraction task are only approximately 80% and 50% respectively. As these results and the results of method 300 are obtained using different corpora, for concreteness, another evaluation using the algorithm of Kanagasabai et. al.³⁷ was performed on the COSMIC gold standard corpus. The average precision and recall achieved using this algorithm for the protein-mutation tuple extraction task is found to be only 77% and 66% respectively whereas the average precision and recall achieved using this algorithm for the mutation grounding task is found to be only 52% and 38% respectively. Thus, it can be seen that method 300 is capable of achieving significant improvements over existing systems or algorithms due to its robust maximal mutant mapping technique.

TABLE 1

| | Protein-Mutation | | Mutation | |
|---|---|---|---|---|
| | Tuple Extraction | | Grounding | |
| Task | Precision % | Recall % | Precision % | Recall % |
| FGFR3 | 99.4 | 69.7 | 71.4 | 54.1 |
| MEN1 | 99.5 | 61.5 | 83.3 | 52.6 |
| PIK3CA | 98.8 | 79.6 | 91.8 | 70.9 |

Furthermore, method 300 is advantageous as it is an ontology-driven workflow for mutation extraction and grounding, where the two tasks are implemented as complementing and reinforcing each other rather than as distinct steps. Although the step of extracting protein names and instances of mutations from text documents in method 300 is akin to for example, the MutationFinder¹², which employs more complex regular expressions and rules, method 300 is different from the approach in MutationFinder in that it extracts instances of mutations from the text documents based on a high recall step and relies on a novel ontology mining and refinement method to improve precision. In particular, method 300 uses a maximal mutant mapping technique that can achieve better results than other algorithms. Furthermore, the applicability of method 300 is not limited to only a few protein families unlike algorithms such as the algorithm of Kanagasabai et al.³⁶ which employs an iterative approach for mutation grounding using a lot of task-specific heuristics, thus limiting its applicability across many protein families.

### REFERENCES

1. M. Olivier, R. Eeles, M. Hollstein, M. A. Khan, C. C. Harris and P. Hainaut. The IARC TP53 database: new online mutation analysis and recommendations to users. Hum Mutat 19, 607-614. (2002).
2. S. Bamford, E. Dawson, S. Forbes, J. Clements, R. Pettett, A. Dogan, A. Flanagan, J. Teague, P. A. Futreal, M. R. Stratton and R. Wooster. The COSMIC (Catalogue of Somatic Mutations in Cancer) database and website. Br J Cancer 91, 355-358. (2004).
3. D. Hamroun, S. Kato, C. Ishioka, M. Claustres, C. Beroud and T. Soussi. The UMD TP53 database and website: update and revisions. Hum Mutat 27, 14-20. (2006).
4. B. Niesler, C. Fischer and G. A. Rappold. The human SHOX mutation database. Hum Mutat 20, 338-341. (2002).
5. K. A. Stenberg, P. T. Riikonen and M. Vihinen. KinMutBase, a database of human disease-causing protein kinase mutations. Nucleic Acids Res 27, 362-364. (1999).
6. P. D. Stenson, E. V. Ball, M. Mort, A. D. Phillips, J. A. Shiel, N. S. Thomas, S. Abeysinghe, M. Krawczak and D. N. Cooper. Human Gene Mutation Database (HGMD): 2003 update. Hum Mutat 21, 577-581. (2003).
7. E. G. Tuddenham, R. Schwaab, J. Seehafer, D. S. Millar, J. Gitschier, M. Higuchi, S. Bidichandani, J. M. Connor, L. W. Hoyer, A. Yoshioka and et al. Haemophilia A: database of nucleotide substitutions, deletions, insertions and rearrangements of the factor VIII gene, second edition. Nucleic Acids Res 22, 4851-4868. (1994).
8. D. Fredman, M. Siegfried, Y. P. Yuan, P. Bork, H. Lehvaslaiho and A. J. Brookes. HGVbase: a human sequence variation database emphasizing data quality and a broad spectrum of data sources. Nucleic Acids Res 30, 387-391. (2002).
9. T. Kawabata, M. Ota and K. Nishikawa. The Protein Mutant Database. Nucleic Acids Res 27, 355-357. (1999).
10. F. Horn, A. L. Lau and F. E. Cohen. Automated extraction of mutation data from the literature: application of MuteXt to G protein-coupled receptors and nuclear hormone receptors. Bioinformatics 20, 557-568. (2004).
11. D. Rebholz-Schuhmann, S. Marcel, S. Albert, R. Tolle, G. Casari and H. Kirsch. Automatic extraction of mutations from Medline and cross-validation with OMIM. Nucleic Acids Res 32, 135-142. (2004).
12. J. G. Caporaso, W. A. Baumgartner, Jr., D. A. Randolph, K. B. Cohen and L. Hunter. MutationFinder: a high-performance system for extracting point mutation mentions from text. Bioinformatics 23, 1862-1865. (2007).
13. C. J. O. Baker and R. Witte. Mutation Mining—A Prospector's Tale. Information Systems Frontiers 8, 47-57. (2006).
14. R. R. Gabdoulline, S. Ulbrich, S. Richter and R. C. Wade. ProSAT2—Protein Structure Annotation Server. Nucleic Acids Res 34, W79-83. (2006).
15. J. McEntyre and D. Lipman. PubMed: bridging the information gap. Cmaj 164, 1317-1319. (2001).
16. D. A. Benson, I. Karsch-Mizrachi, D. J. Lipman, J. Ostell and D. L. Wheeler. GenBank. Nucleic Acids Res 35, D21-25. (2007).
17. C. H. Wu, R. Apweiler, A. Bairoch, D. A. Natale, W. C. Barker, B. Boeckmann, S. Ferro, E. Gasteiger, H. Huang, R. Lopez, M. Magrane, M. J. Martin, R. Mazumder, C. O'Donovan, N. Redaschi and B. Suzek. The Universal Protein Resource (UniProt): an expanding universe of protein information. Nucleic Acids Res 34, D187-191. (2006).
18. H. M. Berman, T. N. Bhat, P. E. Bourne, Z. Feng, G. Gilliland, H. Weissig and J. Westbrook. The Protein Data Bank and the challenge of structural genomics. Nat Struct Biol 7 Suppl, 957-959. (2000).
19. M. K. Smith, C. Welty and D. L. McGuinness. OWL Web Ontology Language Guide. (2004). http://www.w3.org/TR/2003/CR-owl-guide-20030818/
20. S. F. Altschul, T. L. Madden, A. A. Schaffer, J. Zhang, Z. Zhang, W. Miller and D. J. Lipman. Gapped BLAST and PSI-BLAST: a new generation of protein database search programs. Nucleic Acids Res 25, 3389-3402. (1997).
21. J. M. Chandonia, G. Hon, N. S. Walker, L. Lo Conte, P. Koehl, M. Levitt and S. E. Brenner. The ASTRAL Compendium in 2004. Nucleic Acids Res 32, D189-192. (2004).
22. J. D. Thompson, D. G. Higgins and T. J. Gibson. CLUSTAL W: improving the sensitivity of progressive multiple sequence alignment through sequence weighting, position-specific gap penalties and weight matrix choice. Nucleic Acids Res 22, 4673-4680. (1994).
23. M. Y. Shen and A. Sali. Statistical potential for assessment and prediction of protein structures. Protein Sci 15, 2507-2524. (2006).
24. R. Witte, T. Kappler and C. J. O. Baker. Enhanced Semantic Access to the Protein Engineering Literature using Ontologies Populated by Text Mining. International Journal of Bioinformatics Research and Applications. (2007).
25. V. Haarslev, R. Möller and M. Wessel. KI-2004 International Workshop on Applications of Description Logics (ADL '04). (2004).
26. C. J. O. Baker, X. Su, G. Butler and V., Haarslev. Ontoligent interactive query tool. Canadian Semantic Web (Semantic Web and Beyond: Computing for Human Experience), Springer-Verlag New York, Inc. (2006).
27. A. Fadhil and V. Haarslev. 2007 International Workshop on Description Logics (DL-2007), Bressanone, near Bozen-Bolzano, Italy. (June 2007).
28. P. Lambrix, H. Tan, V. Jakoniene, and L. Strömbäck, Biological Ontologies. In: Semantic Web Revolutionizing Knowledge Discovery in the Life Sciences. C. J. O. Baker and K. H. Cheung (eds) Springer 2007
29. C. J. O. Baker, Shaban-Nejad A., Su X., Haarslev V., and Butler G. Semantic Web Infrastructure for Fungal Enzyme Biotechnologists. Journal of Web Semantics, vol. 4(3), 2006. Special issue on Semantic Web for the Life Sciences
30. C. A. Goble, Stevens R., Ng G., Bechhofer S., Paton N. W., Baker P. G., Peim M., and Brass A. Transparent Access to Multiple Bioinformatics, Information Sources. IBM Systems Journal Special Issue on Deep computing for the Life Sciences, 40(2), 2001.
32. Caporaso J G. Rapid Pattern Development for Concept Recognition Systems: Application to Point mutations. 1233-1259, JBCB 2007.
33. Erdogmus M, Sezerman O U: Application of Automatic Mutation-gene Pair Extraction to Diseases. 1261-1275 J. Bioinformatics and Comp Bio. Volume 5, Number 6, December 2007 pp 1261-1275.
34. Witte R, Baker C J O, Towards a Systematic Evaluation of protein Mutation Extraction Systems. J. Bioinformatics and Comp Bio. Volume 5, Number 6, December 2007 pp 1339-1359.
35. K. Wolstencroft, R. Stevens, and V. Haarslev. Applying OWL Reasoning to Genomics: A Case Study. In: Semantic Web Revolutionizing Knowledge Discovery in the Life Sciences, 2007 C. J. O. Baker and K. H. Cheung (eds) Springer 2007
36. R Kanagasabai, K H Choo, S Ranganathan, C. J. O. Baker, A Workflow for Mutation Extraction and Structure Annotation, Journal of Bioinformatics and Computational Biology, vol 5, 6:1319-1337, 2007.
37. R Kanagasabai, K H Choo, S Ranganathan, C. J. O. Baker, Extraction and Grounding of Protein Mutations via Ontology-centric Knowledge Integration, RECOMB 2008.

1. A method of obtaining a correspondence between a protein and a set of instances i=1 . . . , k of mutations of the protein, the method comprising:
a) matching a plurality of protein sequences in a sequence bank to at least one expression formed using the set of instances of mutations wherein each protein sequence comprises a plurality of amino acid residues of the protein's constituent peptides and wherein the at least one expression includes wild type residues of a subset of the instances of mutations in the order of their positions within the protein, and differences in said positions of the successive wild type residues in the expression;
b) ranking the protein sequences according to the similarity of the protein sequences to the set of instances of mutations, the similarity of the protein sequences to the set of instances of mutations being determined by the matching operation (a); and
c) retaining the protein sequence with the highest similarity ranking, said correspondence being a relationship between the retained protein sequence and a subset of the instances of mutations corresponding to the retained protein sequence.

2. A method according to claim 1, wherein if more than one protein sequence has the highest similarity ranking, operation (b) further comprises:
i) computing a sequence offset distance for each protein sequence having the highest similarity ranking, the sequence offset distance depending on the distance(s) between the instances of mutations corresponding to the retained protein sequence; and
ii) ranking the protein sequences having the highest similarity ranking according to the sequence offset distances.

3. A method according to claim 2, wherein the sequence offset distance is an average distance between the instances of mutations corresponding to the retained protein sequence

4. A method of building a knowledge base comprising correspondences between a plurality of proteins and instances of mutations of the plurality of proteins, the method comprising:
obtaining a correspondence between each protein and the instances of mutations of the protein by:
i) matching a plurality of protein sequences in a sequence bank to at least one expression formed using the set of instances of mutations wherein each protein sequence comprises a plurality of amino acid residues of the protein's constituent peptides and wherein the at least one expression includes wild type residues of a subset of the instances of mutations in the order of their positions within the protein, and differences in said positions of the successive wild type residues in the expression;
ii) ranking the protein sequences according to the similarity of the protein sequences to the set of instances of mutations, the similarity of the protein sequences to the set of instances of mutations being determined by the matching operation (i); and
iii) retaining the protein sequence with the highest similarity ranking, said correspondence being a relationship between the retained protein sequence and a subset of the instances of mutations corresponding to the retained protein sequence; and
iv) creating a class instance of the correspondence of the retained protein sequence in the knowledge base.

5. A method according to claim 4, further comprising the following steps prior to the operation (i):
v) extracting the instances of mutations and names of the proteins from text documents; and
vi) extracting protein-mutation relations between the extracted instances of mutations and the extracted names of the proteins, wherein the protein-mutation relation describes the protein that is mutated by the instance of mutation.

6. A method according to claim 5, wherein operation (v) further comprises:
vii) extracting the names of the proteins from the text documents by matching processed text of the text documents against a protein name list; and
viii) extracting the instances of mutations from the text documents by matching the processed text of the text documents against a regular expression [A-Z]([a-z][a-z])?\-?\d+[A-Z]([a-z][a-z])?.

7. A method according to claim 6, wherein if the wild type residue or the mutant residue of an extracted mutation does not match a valid name or letter or if the wild type residue is the same as the mutant residue of an extracted mutation, the operation (viii) further comprises the step of deleting the extracted mutation.

8. A method according to claim 5, wherein operation (v) further comprises the:
ix) normalizing the extracted names of the proteins to canonical names in the protein name list;
x) grounding the extracted names of the proteins to identifiers in the protein name list; and
xi) normalizing the extracted instances of mutations to a wNm format where w represents the wild type residue of the extracted instance of mutation, m represents the mutant residue of the extracted instance of mutation and N indicative of the position of the wild type residue of the extracted instance of mutation within the protein wherein w and m are one-letter amino acid codes.

9. A method according to claim 5, wherein operation (vi) is performed by determining that a protein is mutated by an instance of mutation if the instance of mutation and the name of the protein appear in a same sentence of the text documents.

10. A method according to claim 5, further comprising instantiating the knowledge base with the extracted instances of mutations, the extracted names of the proteins and the extracted protein-mutation relations.

11. A method according to claim 10, wherein the extracted instances of mutations and the extracted names of the proteins are instantiated as class instances, and the extracted protein-mutation relations are instantiated as Object Property instances.

12. A method according to claim 4, further comprising:
xii) retrieving protein sequences from a sequence bank; and
xiii) instantiating the knowledge base with the retrieved protein sequences.

13. A method according to claim 12, wherein sub-operation (xiii) further comprises the sub-operation of:
ix) populating the retrieved protein sequences under a class in the knowledge base; and
x) creating object property instances for the proteins, the object property instances relating the proteins to the retrieved protein sequences.

14. A method according to claim 1, wherein the operation (a) further comprises the following sub-operation (14a) and (14b):
(14a) repeatedly performing the following sub-steps (14i)-(14iii):
(14i) forming a subset of the instances of mutations, the subset including a plurality of the instances of mutations;
(14ii) forming a corresponding expression for the subset, wherein the corresponding expression includes the wild type residues of the subset of mutations in the order of their positions within the protein, and the differences in said positions of the successive wild type residues of the subset of mutations; and
(14iii) matching each protein sequence to the corresponding expression; and
(14b) for each protein sequence, extracting the longest corresponding expression that matches the protein sequence.

15. A method according to claim 14, wherein each instance of mutation specifies a corresponding wild type residue wᵢ, a corresponding number Nᵢ indicative of the position of the wild type residue wᵢ within the protein, and a corresponding mutant residue mᵢ which is made to the corresponding wild type residue wᵢ and the corresponding expression is of the form w₁·{f₁}w₂·{f₂} . . . {fₖ₋₁}·wₖ wherein fᵢ is the difference in the positions of the successive wild type residues wᵢ and wᵢ₊₁ of the subset of mutations.

16. A method according to claim 14, wherein operation (b) further comprises the sub-operation of ranking the protein sequences by assigning a highest similarity ranking to the protein sequence for which the corresponding longest expression is longest.

17. A method according to claim 16, wherein if it is found that more than one said protein sequence is such that the corresponding longest matching expression is longest, those protein sequences are ranked by:
computing a corresponding sequence offset distance of the longest matching expression, the sequence offset distance depending on the distance(s) between the corresponding subset of instances of mutations; and
identifying the protein sequence for which the corresponding sequence offset distance is smallest.

18. A method according to claim 17, wherein the sequence offset distance is an average distance between the instances of mutations in the corresponding subset of instances of mutations.

19. A method according to claim 14, wherein the subsets of the instances of mutations comprise at least one generation of subsets which share a first instance of mutation, each generation of subsets formed by:
generating a first subset of the generation consisting of said first instance of mutation;
successively generating further subsets by:
(19i) adding to the most recently generated subset of the generation an instance of mutation at a subsequent position within the protein, to form a new subset of the generation;
(19ii) generating a corresponding said expression for the new subset;
(19iii) determining whether the corresponding expression for the new subset of the generation matches at least one of the protein sequences; and
(19iv) if not, removing the instance of mutation at said subsequent position.

20. A method according to claim 19, wherein the subsets in each generation begin with an instance of mutation at a position subsequent to the position of the instance of mutation the subsets in a previous generation begin with.

21. A method according to claim 19, wherein each generation of subsets ceases after an instance of mutation at the furthest position, k, within the protein is included.

22. A method according to any claim 19, wherein the subsets in the final generation comprise two elements.

23. A method according to claim 3, wherein operation (c) further comprises the sub-operation of uninstantiating the remaining protein sequences and the instances of mutations not matching any protein sequences.

24. A computer system having a processor and a data storage device, the data storage device carrying program instructions operative when performed by the processor to cause the processor to obtain a correspondence between a protein and a set of instances i=1 . . . , k of mutations of the protein, by:
a) matching a plurality of protein sequences in a sequence bank to at least one expression formed using the set of instances of mutations wherein each protein sequence comprises a plurality of amino acid residues of the protein's constituent peptides and wherein the at least one expression includes wild type residues of a subset of the instances of mutations in the order of their positions within the protein, and differences in said positions of the successive wild type residues in the expression;
b) ranking the protein sequences according to the similarity of the protein sequences to the set of instances of mutations, the similarity of the protein sequences to the set of instances of mutations being determined by the matching in operation (a); and
c) retaining the protein sequence with the highest similarity ranking, said correspondence being a relationship between the retained protein sequence and a subset of the instances of mutations corresponding to the retained protein sequence.

25. A tangible data storage device, readable by a computer and containing instructions operative when performed by a processor of a computer system to cause the processor to obtain a correspondence between a protein and a set of instances i=1 . . . , k of mutations of the protein, by:
a) matching a plurality of protein sequences in a sequence bank to at least one expression formed using the set of instances of mutations wherein each protein sequence comprises a plurality of amino acid residues of the protein's constituent peptides and wherein the at least one expression includes wild type residues of a subset of the instances of mutations in the order of their positions within the protein, and differences in said positions of the successive wild type residues in the expression;
b) ranking the protein sequences according to the similarity of the protein sequences to the set of instances of mutations, the similarity of the protein sequences to the set of instances of mutations being determined by the matching in operation (a); and
c) retaining the protein sequence with the highest similarity ranking, said correspondence being a relationship between the retained protein sequence and a subset of the instances of mutations corresponding to the retained protein sequence.
